(19) United States
(12) Patent Application Publication
(10) Pub. No.: US 2016/0217538 A1
(43) Pub. Date: Jul. 28, 2016

(54) Network Social Messaging System Including Social Recognition Messages Redeemable by Recipients for Value

(71) Applicant: Behrang M. Garakani, San Francisco, CA (US)

(72) Inventor: Behrang M. Garakani, San Francisco, CA (US)

(21) Appl. No.: 14/981,482

(22) Filed: Dec. 28, 2015

Related U.S. Application Data
(60) Provisional application No. 62/108,941, filed on Jan. 28, 2015.

(51) Int. Cl. G06Q 50/18; G06Q 30/02

(52) U.S. Cl. CPC G06Q 50/184; G06Q 30/0283

(57) ABSTRACT

A computer-implemented method for managing recognition accounts stored in a social network system, comprising providing content to a patron computer, determining whether the content is able to result in monetary compensation, including, within a presentation format of the content, a user interface feature usable to signal an authorization for monetary compensation for the content, accepting, from the patron computer, an indication of a request to provide monetary compensation to a creator of the content, determining, using the patron computer or the social network system, based on patron actions or patron default settings, whether to give nonmonetary recognition for the content, updating a nonmonetary recognition database based on nonmonetary recognition given for the content, and transferring amounts among recognition accounts.

### CROSS-REFERENCES TO PRIORITY AND RELATED APPLICATIONS

This application claims the benefit of U.S. Provisional Patent Application No. 62/108,941 filed Jan. 28, 2015 entitled “System and Method for Assigning Monetary Value to Social Recognition”.

The entire disclosure(s) of application(s)/patent(s) recited above is (are) hereby incorporated by reference, as if set forth in full in this document, for all purposes.

### FIELD OF THE INVENTION

The present invention relates generally social networking and more particularly to social networking system that are programmed to accept user input as to social recognition of contributions of contributors and for compensating those contributors.

### BACKGROUND

Social networks allow different individuals, business entities, organizations and other participants to interact over a computer network. Typically, a social network might be implemented by a centralized, distributed or peer-to-peer content host having network connections, such as Internet-based communication channels, to participant computers. A participant can use their participant computer to create content, obtain content, and then upload that content to the social network host. The participant can also use their participant computer, or other device(s), to view, download, or otherwise interact with content uploaded by that participant or other participants. The uploading of content for access by other participants is often referred to as “posting” content. One participant's posted content might be visible to all other participants, visible to a subset of “friends” selected by the participant, or according to some other rules or rule set determined by an operator of the social network host. The posted content might comprise images, text, video, and/or commentary on the postings of others. A participant might view content in the form of a “feed” containing a listing of some or all of the postings of that participant's friends. The social network host might execute programs to sort and filter content for the participant's feed, which might be useful where a participant is not likely to be able to, or want to, view all of the postings of all of the participant's friends.

The social network host might control and manage the posting and viewing of content using one or more participant databases. For example, a user database might contain records about each active participant, such as e-mail, advertising preferences, topics of interest, posting history, viewing history, and references to stored content that the participant posted. A social network database might contain records about what connection exist between participants, such as the fact that “participant A” and “participant B” are linked and designated as friends in the social network. In the case of a business, the links might be to individuals having expressed an interest in that business. In some social network hosted configurations, the links in the social network need not be entirely symmetrical, in that a participant might be a friend or follower of another participant who is not necessarily a friend or follower. That might be the case where a large number of people want to follow the postings of a celebrity, but that celebrity does not want to, or is not able to, follow the postings of all of their followers.

These same issues might arise in content posting networks that do not necessarily have a social network fabric. For example, a content posting network might host videos uploaded by creators and allow for viewing, commenting, upvoting, downvoting, etc. of the uploaded videos.

In some cases, maintaining a timely stream of postings can require considerable amount of time. Some participants might post thoughtful and researched comments on a regular basis, reacting to timed events, such as news occurrences, other online activity, or the like. Those participants might not be able to keep up with the regular basis except for those who have a job that requires them to maintain a regular stream of postings. Nonetheless, some participants who are not already compensated for creating content might continue to create good content if they could be compensated. In some instances, content creators have relied on advertising that is interspersed in the content they post and some of that is in the form of sponsored postings. One reason for advertising-supported content creation is that it furthers the brand of the advertiser. Another reason for advertising-supported content creation is that it is and efficient form of collecting compensation for having a large number of followers.

### SUMMARY

In various embodiments, a computer-implemented method is provided for managing recognition accounts stored in a social network system, comprising providing content to a patron computer, determining whether the content is able to result in monetary compensation, including, within a presentation format of the content, a user interface feature usable to signal an authorization for monetary compensation for the content, accepting, from the patron computer, an indication of a request to provide monetary compensation to a creator of the content, determining, using the patron computer or the social network system, based on patron actions or patron default settings, whether to give nonmonetary recognition for the content, updating a nonmonetary recognition database based on nonmonetary recognition given for the content, and transferring amounts among recognition accounts.

The following detailed description together with the accompanying drawings will provide a better understanding of the nature and advantages of the present invention.

### BRIEF DESCRIPTION OF THE DRAWINGS

Various embodiments in accordance with the present disclosure will be described with reference to the drawings, in which:

FIG. 1 is an illustrative example of method in accordance with at least one embodiment.

FIG. 2 is an illustrative example of a user interface that might be used on a device for signaling support for content and/or authorization for monetary compensation for the content.

FIG. 3 is a block diagram of an example device that might provide the user interface of FIG. 2, provide server services, or provide other computing functionality.

FIG. 4 is a block diagram of memory structures that might be used.

FIG. 5 is a schematic of a networked computer arrangement that might be used.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The social networking system described herein includes some conventional elements that need not be described in detail as those are readily known and available. For example, a social networking system can operate using a host (distributed, centralized, or otherwise) that maintains content including content provided by participants in the social network and provides that content to participant computers of participants in the social network. The social network host might include database servers, web servers, load managers, and the like. The participant computers might comprise desktop computers, tablets, smartphones, wearable devices, embedded systems, etc. that contain a browser, an app interface, or some other structure that allows the participant to obtain, view, enter and submit content to and from the social network host.

One novel feature of the social networking system described herein is that the system is programmed to track and maintain data about social recognition of contributions of contributors and for compensating those contributors, such as by coordinating messages to allow for secure transfer of monetary value from participants who are issuing social recognition and participants receiving that social recognition. While the examples below may use some currency as the unit of social recognition, the system need not be so limited.

In a specific example embodiment, the social networking system responds to feed requests from participants by providing those participants with content feeds in a computer-readable form, such as XML, HTML, or other structured form understandable to the participant computer. The structured form also includes user interface elements associated with content items that allow the receiving participant to indicate an amount of social recognition currency to transfer from the receiving participant's recognition account to the recognition account of the content creator. Each party can arrange to have their recognition account coupled to a bank account, credit card, or other financial vehicle, to move funds in and out of their recognition account as desired. By including those user interface elements, the social networking system provides an easy, quick, reliable, and secure mechanism for content consumers to compensate content creators at their discretion.

As an example, an author A might post a funny story using the author's computer and social network account. Suppose that 10,000 other social network participants read the funny story, and some of those that liked the story could “upvote” the story. Suppose that 500 of those that liked the story chose to give $0.05 of social recognition to that funny story by pressing a button displayed on screen near the display of the funny story. With each of the participants having a recognition account managed by the operator of the social network system, the social network system can debit each of those givers' recognition account by $0.05 and credit the content creator's recognition account by $25.00. The operator of the social network system might maintain a fees account to defray operating costs. For example, the credit to the content creator's recognition account might be $24.90 with a credit to the fees account of $0.10. In this example, the upvotes could be used to determine which content is shown preferentially over other content, which promotes good content, and the recognition accounts of content creators would also promote good content as well as providing funding to allow for additional content creation supported by viewers of that content.

Content creators might be authors, comedians, news reporters, feature film creators, performance artists who film and post film of their performances, game developers, and others who can provide content of interest to others over a computer network.

Content creators who provide freely available content have limited options to earn income, such as through advertising third-party content alongside their content, selling products associated with that content (coffee mugs, T-shirts, etc.), or individually asking for donations from patrons. This can create a barrier between the content consumers who have no need for additional product, are not interested in the advertised products, but would make a small monetary contribution if it required a minimum of effort.

Example currencies include digital currencies, physical currencies, regulated and unregulated, as well as centralized and decentralized. Redemption of social recognition currency might be in the currency granted, but might convert to a more preferred currency.

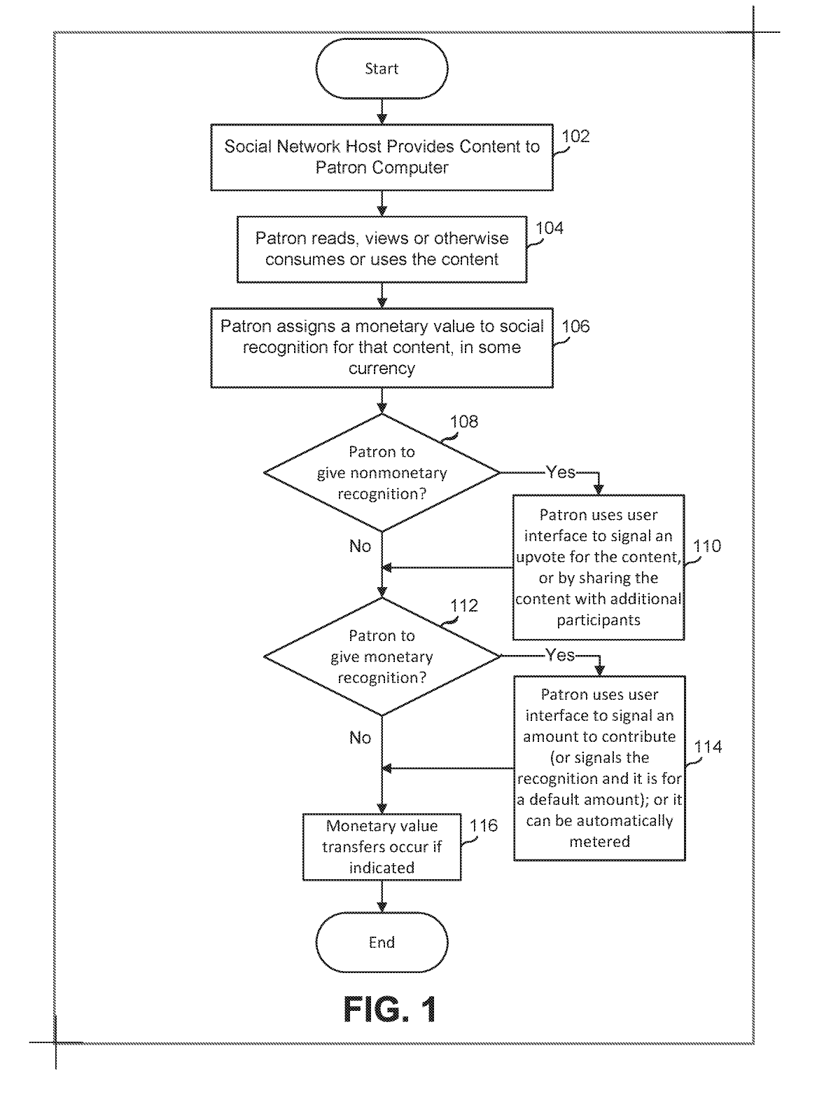

FIG. 1 illustrates an example of such a process. In that FIG. 1, the contributing participant is referred to as the “patron” and the content creator and/or owner is referred to as the “creator.” In some instances, a social network participant may act as a patron (e.g., using their computer to signal a request to transfer monetary value from their recognition account managed by the operator of the social network system upon viewing created content) and also as a creator (e.g., using their computer to upload content).

In step 102, the social network host provides content to the patron computer. The host might do this by examining databases of content posted by certain participants at certain times based on patron preferences and providing a content feed to the patron computer. The content feed might include content created without expectation of compensation, such as a friend posting images of their pet, food, children or updates on their activities. The content might include content created with an expectation of compensation, such as a complex computer game or thoughtful image. The content might include content created with an unknown motivation, such as a commentary on politics that one might post even in the absence of compensation but where compensation from appreciative readers would be nice.

The social network system might be agnostic as what nature of content would include the user interface feature allowing for consumers of the content to signal a monetary recognition. For example, it might be possible for some viewers to compensate someone who posts pictures of what they happen to be eating at the time, even though that might be highly unusual. On the other hand, with some variations of the social network system, a filter might be used so that not all content is provided with the user interface feature that allows for patrons to signal monetary recognition.

In step 104, the patron reads, views or otherwise consumes or uses the content, such as by reading, viewing video, playing a game, taking an online survey, or the like.

In step 106, the patron assigns a monetary value to social recognition for that content, in some currency. The social network system might manage more than one currency, some of which might be pegged to actual national currencies or virtual currencies or value measures (e.g., “points”) redeemable only within the social network system. The social network system may also manage unregulated currencies, such as airline miles, specific branded point system points, in-game currencies, or the like.

In step 108, the patron's computer or the social network system determines, based on the patron's actions or the patron's default settings, if any, whether to give nonmonetary recognition, such as an upvote for content or by sharing the content with additional participants. Another example of nonmonetary recognition is the patron signaling a request to subscribe to receive content from that content provider or to follow that content provider. Passive nonmonetary recognition might be provided by the patron, in the form of adding page views, watching videos, listening to music, playing games, or the like that are metered and provide a popularity indication.

At step 110, if nonmonetary recognition is to be given, the patron uses the patron computer user interface to signal an upvote or a share. For example, there might be HTML buttons presented on a web page displayed by a browser that the user selects, which in turn causes a message to be sent to the social network system, which then refreshes the page to provide feedback that the button was pressed and the upvote or share was accounted for, and then the social network system might update its content database to account for the additional upvote.

In step 112, the patron's computer or the social network system determines, based on the patron's actions or the patron's default settings, if any, whether to give monetary recognition, such as a transfer among recognition accounts and, if so, the amount and the currency where multiple currencies are used.

At step 114, if monetary recognition is to be given, the patron uses the patron computer user interface to signal an amount and a currency or uses default values. For example, there might be HTML buttons presented on a web page displayed by a browser that the user selects, which in turn causes a message to be sent to the social network system, which then refreshes the page to provide feedback that the button was pressed. The page for the patron's computer might be refreshed to show a new current balance in the patron's recognition account.

In step 116, if there was a monetary transaction, the social network system handles the changes in the recognition accounts as indicated.

### Variations

In other variations, the content itself is off-line, but the social recognition is still online. For administrative simplicity, the system operator and/or content providers might set a minimum transaction amount. For security, participants might set limits on the amount of transfer from their recognition account.

In some variations, businesses might give monetary recognition or nonmonetary recognition to participants, perhaps in response to participant actions. A business might give such recognition in their own digital currency, such as an airline recognizing a participant by sending airline miles or store credits or coupons for the participant posting something helpful to that business.

In some variations, the postings are in a content posting network that does not necessarily have a social network fabric. For example, a content posting network might host videos uploaded by creators and allow for viewing, commenting, upvoting, downvoting, etc. of the uploaded videos. Participants might not have any prior connection to the creator, or might be subscribers in the content posting network, but those participants could still provide social recognition to those creators.

### Additional Details

Most content creators such as artists, bands, filmmakers are having a difficult time earning a living. Only those with millions of hits or views are making enough money on advertising to focus on their craft, but the staggering majority are still working other jobs to make ends meet. Though they have loyal fans, they don't meet the minimal thresholds for advertising revenue. Their fans and patrons already provide them social recognition such as Likes, Shares, Favorites, & Retweets, but fans rarely have a way to pay those content creators directly.

Inspired by buskers who work subways, parks, and streets around the world, Social Recognition Currency Units (“SRCUs”) are a way for patrons to give monetary support to their favorite content creators online. SRCUs are a form of micro-currency payments that are attached to the social recognition content creators receive directly from their fans and patrons. So when content owners receive a Like from their fan, the fan will also send the content owner an SRCU. This provides content creators another revenue model outside of selling products or services, advertising, or subscriptions.

The social recognition that forms the currency in the social networking system can be based on a regulated currency or an unregulated currency. In the examples herein, social recognition is measured in SRCUs such as the bitlikes(tm) currency, and may be pegged to other currencies or not. SRCUs can be used to easily monetize content creation and discovery online and offline.

In one variation, the program is run by a social network system operator. In another variation, the program is independent of any one social network system. In the independent system, users sign up for the service, and ascribe a monetary value to each product, service or content they like on social networks and stand-alone Internet sites. The SRCU management system automatically recognizes the action and without further user intervention, seamlessly rewards the content creators or the social influencers who distribute such experiences across the Internet.

The use of the SRCU management system creates a new revenue model for content creators and influencers, since each user endorsement translates to direct monetary value. SRCUs help musicians, writers, designers and artists to earn additional money to support their craft. The service will encourage content discovery, since social influencers would be rewarded for finding and distributing the “hidden gems” of the Internet.

The SRCU management system can provide artists and other content creators with money directly from their fans through their patrons' social recognition. When patrons give social recognition, a number of SRCUs is attached and moves from the patron to the content creator, in an asynchronous, digital form of busking. SRCUs can fill a need in the market in an era where content is expected to be free, but with a community of fans willing to pay for what they consider to be great content. The SRCU management system can provide a method of payment that is on the end of the content lifecycle when the content is already produced and released to the public. There are limited alternative options for patrons and fans to send funds to the content creators whereby the patron initiates the transfer of funds. Other methods require that content creators set up payment options and ask their fans to pay. With SRCUs, patrons see content, like it, and then have a frictionless method to pay the content creator using simple user interfaces.

The patrons and content providers can connect their recognition accounts to other accounts, such as credit cards, debit cards, online payment accounts, bank accounts, etc. The default currency that displays for a participant can be based on the participant's location. These various accounts might be handled via a “wallet” module or service. For example, a wallet module might provide the user a secure interface to view details of the user's financial accounts and funds in those accounts, such as bank, checking, savings, etc. accounts and to initiate transactions with respect to those accounts. Different patrons/providers might use different wallet modules/services, but they would still be interoperable.

The SRCU management system might overlay other social networks and provide network-specific defaults. For example, a participant can specify what social network signaling options will correspond to an SRCU transfer and the number of SRCUs, such as:

Facebook: Like (enabled; 5), Share (enabled; 2)

YouTube: Like (enabled; 3), Share (enabled; 3), Play (disabled), Subscribe (enabled; 1 per month)

Twitter: Favorite (enabled; 1), Retweet (enabled; 2)

Instagram: Like (enabled; 4), Share/Tweet (enabled; 4)

Soundcloud: Like (enabled; 5), Share (enabled; 5)

The SRCU management system might allow a participant to filter in or out specific groups/circles, individuals, or organizations. For example, “everyone receives SRCUs except for A, B, and C.” or “those who are in my Family circle for Google+ will not receive any SRCUs when I provide them with social recognition.”

The SRCU management system might allow a participant to increase the amount of

SRCUs sent to certain groups/circles, individuals, or organizations. For example, “whenever I provide social recognition for D, send them 1000 SRCUs instead of the normal amount I send to everyone else.”

The SRCU management system might do transfers immediately, or might delay them, to allow a participant to change their mind.

A wallet might be an account held and managed by the operator of the SRCU management system and be funded from another account held by the user. That wallet account can funded on a continuous basis, funded automatically when funds are low/depleted, along with the patron setting daily/weekly/monthly maximums for SRCUs given away.

The SRCU management system might handle subscriptions, wherein subscribing to content would send some number of SRCUs per time period as defined by the patron.

The SRCU management system might provide reports of all contributions on a daily, weekly, monthly, and/or yearly basis. The SRCU management system might provide reports usable for tracking contributions made to verified non-profit organizations for tax deduction purposes.

The SRCU management system might allow for periodic repeating contributions. The contributions can be anonymous. While wallet modules/services do not operate anonymously so that transactions can be properly processed, it is possible for a patron to send funds anonymously. To send funds anonymously, the operator of the SRCU management system can set up an account to receive funds from the patron and send a corresponding amount to the content creator without revealing the patron identity.

More generally, the SRCU management system can operate in a number of ways to facilitate patronage. For example, (a) the funds can go directly from the patron directly to the creator, (b) the funds from the patron can go from the patron to the central organization and then the organization can send all or some of the funds to the creator, or (c) some combination of (a) for some funds and (b) for other funds.The SRCU management system might allow for participant actions to see what's trending with SRCUs sent/received as featured by SRCUs, who is receiving the most SRCUs today/this week/this month/this year, who is giving the most, etc. to discover trending content creators, influencers, and patrons.

The SRCU management system might maintain a monetary recognition database of all or all of a subset of transactions for data analysis. The SRCU management system might also maintain a nonmonetary recognition database of all or all of a subset of transactions for data analysis. The nonmonetary recognition might be in the form of social network recognition and/or be combined with social recognition data extracted from various social networks. For example, data can be pulled through various API calls to the social network servers, data can be pulled directly from a database within the social network infrastructure, and/or data can be pushed from the patron to the SRCU management system, such as through a browser extension.

The SRCU management system might be integrated with an interface that the patron uses to view content. For example, the SRCU management system might provide a patron with a social media feed over an interface that allows for the patron to donate directly. Within this interface, the SRCU management system would be able to directly catch the user interaction of social recognition and move the SRCU from patron to the content owner/influencer accordingly. In some cases, this might be preferred over pulling the data ex post facto.

The SRCU management system might allow for, along with giving SRCUs to content creators, optionally giving additional SRCUs to the SRCUs organization itself as a way of support.

The SRCU management system might pay participants in SRCUs for performing actions such as setting up an SRCU account or wallet and/or for each social network linked to the account.

The SRCU management system might filter for proximity so that SRCUs can be given to those in proximity, such as local street performers, for recognition of offline performance as is done with online performance. As an example, creators might be performing live and have personal devices, such as mobile computers or smartphones, with them. Using proximity detection of a creator's personal device, patrons can find that creator based on this proximity. Proximity detection can be through technology such as, but not limited to, GPS, WiFi, NFC, and Bluetooth. The recognition can asynchronous such that the creators need not be at the location when the patrons experience the content. If the creators geotag their content, a patron can use their smartphone to look up the content based on proximity to that geotag. For example a street artist might create a mural on a wall and later a patron finds the artist based on their proximity to the art. The patron can then give recognition to the artist online, as well as giving SRCUs.

The content can also be temporal in association with the geotag. This can be a light show, concert, fireworks, etc. If patrons experience art at a certain place at a certain time, they can discover the creators and give them recognition. Visual and audio recognition can be used to discover the creator, so a participant can use their smartphone camera to identify the creator of a mural. More explicitly, this can be unique computer-recognized codes such as QR codes.

The SRCU management system might provide a participant with a ranking as a contributor relative to their social networks.

The SRCU management system might provide users with different types of accounts with tiered access to functionality beyond the standard account such as a “professional” account.

The standard account might provide content providers with ability to:

1) Receive an SRCU before the recipient is set up with an SRCU account or wallet. If so, create a token/code for the SRCUs and send a notification to the recipient. That token/code can be applied when creating the SRCU account. If many SRCUs are received, the value of the token is increased automatically in lieu of many tokens.

2) Creator can exchange part or all of SRCU wallet balance (whenever feasible logistically) for another form of digital currency or like-value, such as: transfer funds to linked bank account or debit card, donate funds to choice of charity even for nonprofit creators (as might be used for celebrities who can use the social media influence to raise funds for their favorite non-profit); gift cards for retailers; miles for airlines.

3) Verify their creator accounts on social networking and content hosting systems, possibly using existing verifications already in place for those systems.

4) Designate accounts as being for registered non-profit entities.

5) Act as a patron as well as a content creator.

6) Interface over an API for SRCUs to place a SRCU button on the content creator's app or website for patrons to instantly send SRCUs.

7) Configure profile to include categories so patrons can find the content creator.

The professional account might provide content providers with ability to:

1) Receive a report of everyone who has contributed SRCUs, by users, time, content, social network, geography, platforms, market segments, and other selectable data points in a live report.

2) Provide social recognition back to those who gave SRCUs and supported creative endeavors, such as a tweet, Facebook update, email, etc.

3) Let local patrons discover the provider as a street performer.

SRCUs might be unregulated virtual currency built on the bitcoin distributed platform. The SRCU management system might integrate with several existing wallet services, allowing participants to choose a wallet service they use already. When participants link a new social network, they can grant the SRCU management system access to their activity log, favorites, friends, and other data points so that the SRCU management system has enough data points to send SRCUs from patron to content creator. In addition, with access to the activity log goes back in the past, the SRCU management system can generate simulations for participants to see what the amount of SRCUs they would have given and received based on past data using default parameters.

The SRCU management system might delay payments to be able to check that the listed content creator is actually the content creator and, if not, provide an opportunity for the true content creator to come forward and claim the SRCUs generated by that content.

### Example Hardware

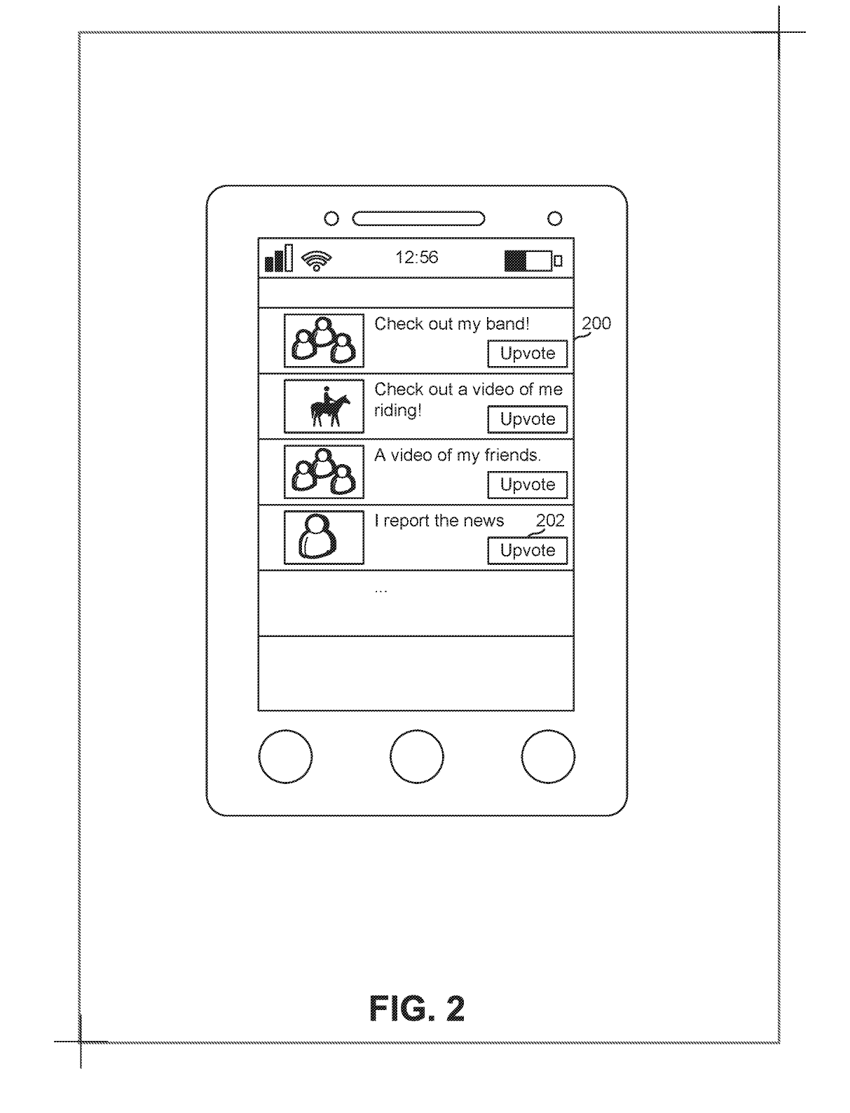

FIG. 2 is an illustrative example of a user interface that might be used on a device for signaling support for content and/or authorization for monetary compensation for the content. The user interface might be provided by a smartphone or other computing device. In this example, the user interface provides the user with a listing 200 of content items, with an “upvote” button 202 for each content item. By selecting the upvote button, the user can then indicate whether to provide nonmonetary recognition and/or monetary recognition. The nonmonetary recognition might be in the form of social networking tallies of users who have provided nonmonetary recognition (e.g., “Likes”, upvotes, etc.). The monetary recognition would result in funds transfers or other processes as described elsewhere herein.

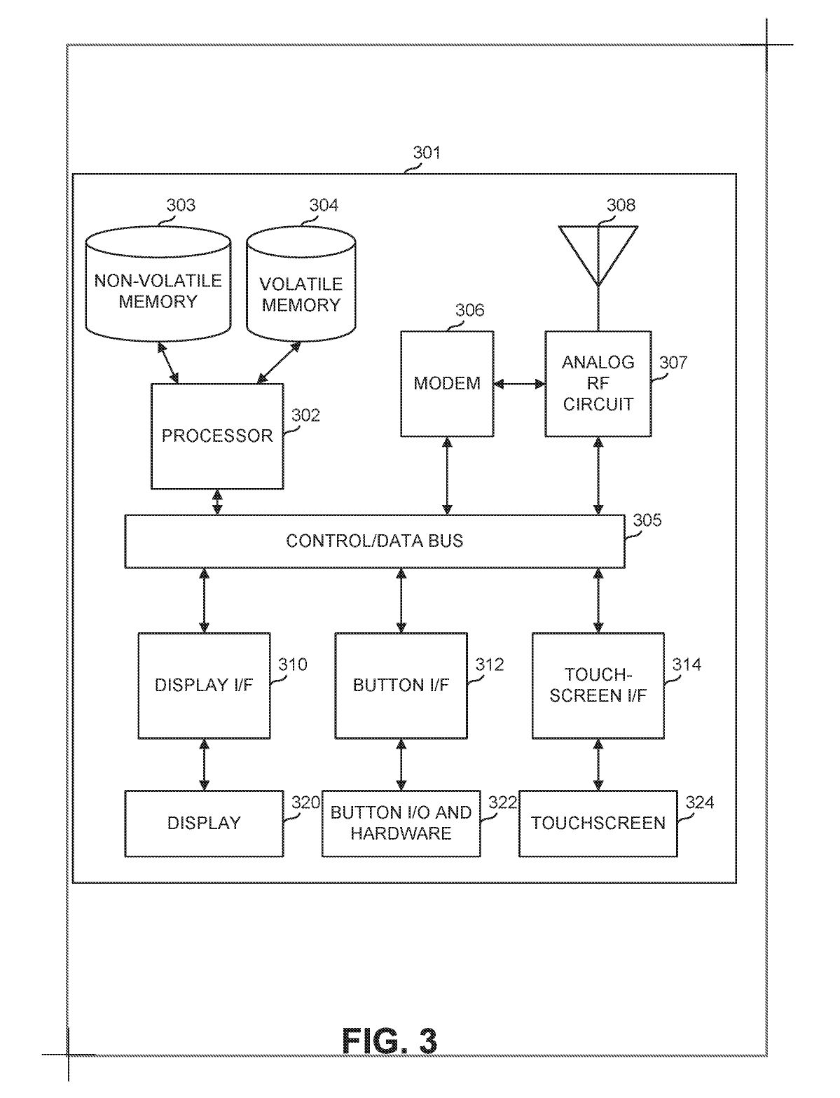

FIG. 3 is a block diagram of an example device 301 that might provide the user interface of FIG. 2, provide server services, or provide other computing functionality. The functionality can be provided by application software executing on operating system software or an equivalent. As illustrated in FIG. 3, a processor 302 interfaces with non-volatile memory 303 and volatile memory 304. Non-volatile memory 303 might contain program code executed by processor 302 to perform various functions of device 301. Volatile memory 304 might store working variables. Processor 302 also interfaces with a control/data bus that allows processor 302 to interact with a modem 306 that might use a radio frequency circuit 207 and an antenna 308 to communicate wirelessly beyond device 301.

Processor 302 also interfaces to a display 320 using a display interface 310, buttons and other hardware 322 using button interface 312, and possibly also a touchscreen 324 using a touchscreen interface 314. In this manner, processor 302 (which might be one or more processing units) can perform the steps and operations described herein that are to be performed by a computer.

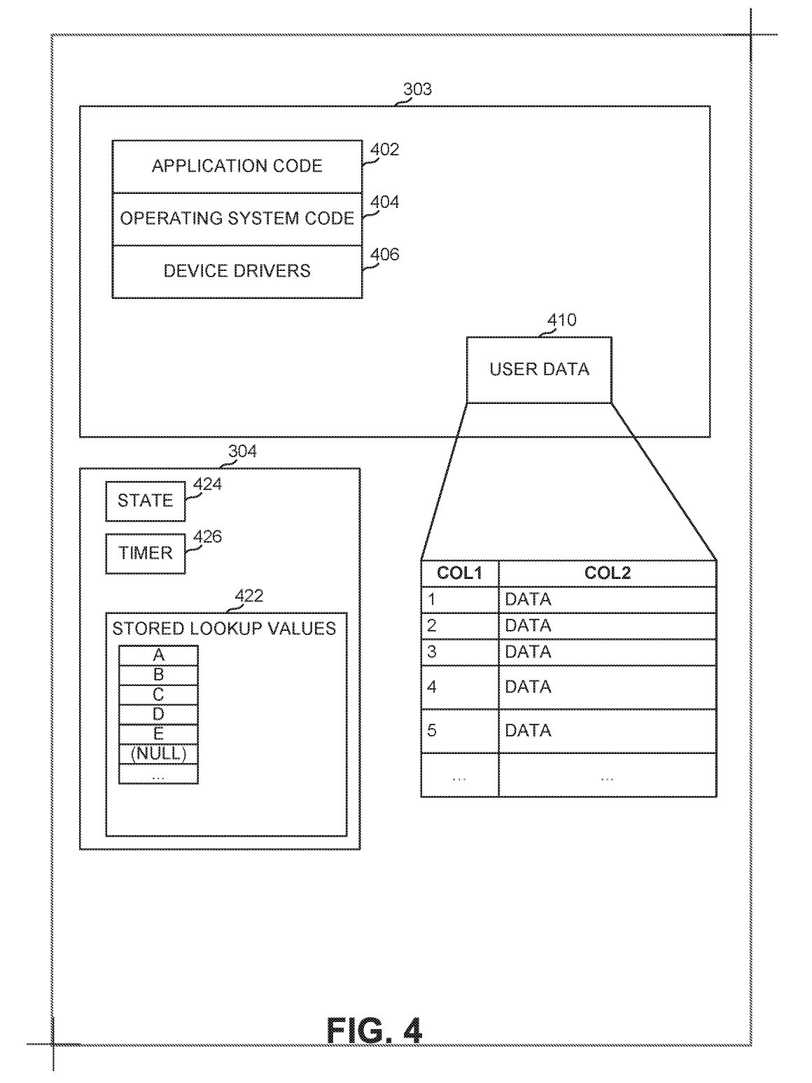

FIG. 4 is a block diagram of memory structures that might be used in non-volatile memory 303. Those structures might include storage for application code 402 that processor 302 executes to perform methods described herein, operating system code 404 and device drivers 406, if needed. Non-volatile memory 303 might also contain user data 410 that includes user-specific data, such as sites visited, user credentials, pointers to banking information and the like specific to the user using device 301 to provide nonmonetary recognition and/or monetary recognition.

FIG. 4 also shows a block diagram of memory structures that might be used in volatile memory 304, such as state variables 424, a timer 426, and stored lookup values 422 used during execution of various programs by processor 302.

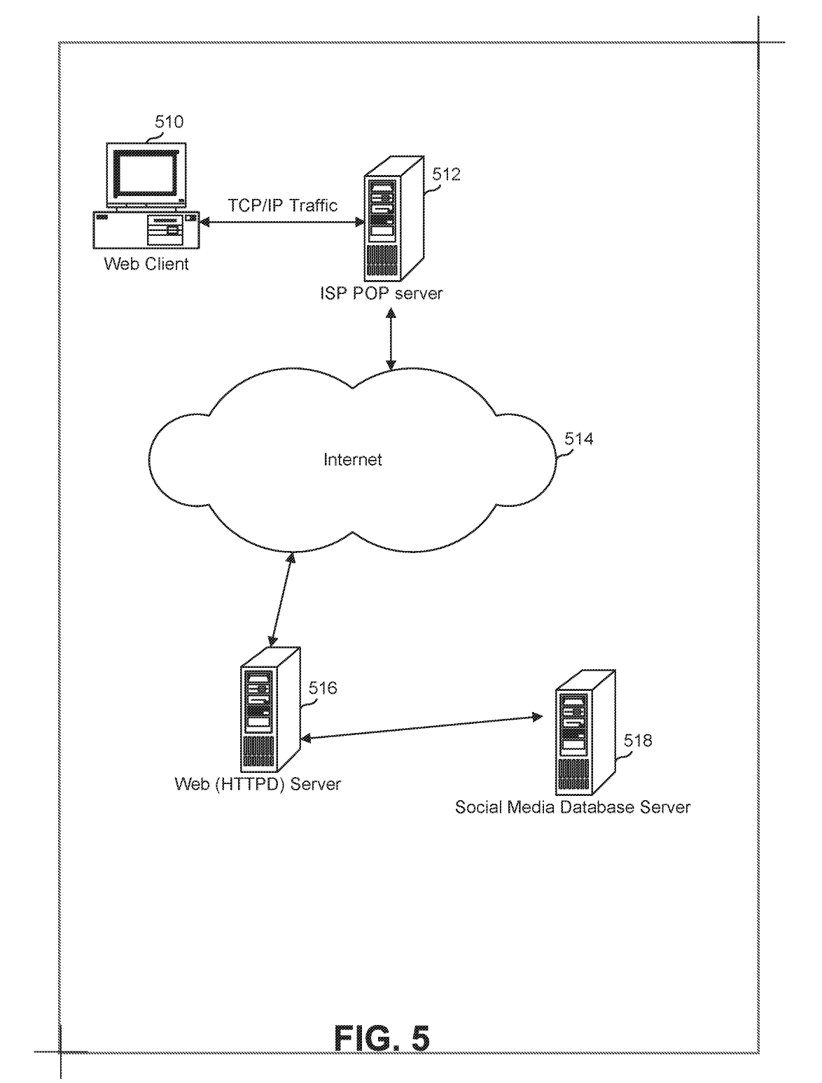

FIG. 5 is a schematic of a networked computer arrangement that might be used. As illustrated there, a web client 510 interacts with an Internet Service Provider computer 512 that communicates over a network 514, such as the Internet, with a web server 516 that connects to a social media database server 518. Such infrastructure might be used for a user to obtain content on a user device and provide nonmonetary recognition and/or monetary recognition to content providers.

### Implementation Variations

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof The code may be stored on a computer-readable storage medium, for example, in the form of a computer program comprising a plurality of instructions executable by one or more processors. The computer-readable storage medium may be non-transitory.

The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and it should be understood that combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

What is claimed is:

1. A computer-implemented method for managing recognition accounts stored in a social network system, comprising:
providing content to a patron computer;
determining whether the content is able to result in monetary compensation;
including, within a presentation format of the content, a user interface feature usable to signal an authorization for monetary compensation for the content;
accepting, from the patron computer, an indication of a request to provide monetary compensation to a creator of the content;
determining, using the patron computer or the social network system, based on patron actions or patron default settings, whether to give nonmonetary recognition for the content;
updating a nonmonetary recognition database based on nonmonetary recognition given for the content; and
transferring amounts among recognition accounts.
